(19) United States
(12) Patent Application Publication
(10) Pub. No.: US 2007/0154752 A1
(43) Pub. Date: Jul. 5, 2007

(54) Starting up and shutting down a fuel cell stack

(76) Inventors: James F. McElroy, Suffield, CT (US); Dylan T. Davis, Ballston Lake, NY (US); Michael D. Gasda, Albany, NY (US)

Correspondence Address: TROP PRUNER & HU, PC, 1616 S. VOSS ROAD, SUITE 750, HOUSTON, TX, 77057-2631, US

(21) Appl. No.: 11/321,400

(22) Filed: Dec. 29, 2005

(51) Int. Cl. H01M 8/04

(52) U.S. Cl. 429/22; 429/34; 429/13; 429/17

(57) ABSTRACT

A technique includes shutting down operation of a fuel cell stack that includes an anode chamber and a cathode chamber. The shutting down includes storing fuel in the anode and cathode chambers of the fuel cell stack.

### BACKGROUND

The invention generally relates to shutting down and starting up a fuel cell stack.

A fuel cell is an electrochemical device that converts chemical energy directly into electrical energy. For example, one type of fuel cell includes a proton exchange membrane (PEM), that permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system includes various other components and subsystems, such as a cooling subsystem, a cell voltage monitoring subsystem, a control subsystem, a power conditioning subsystem, etc. The particular design of each of these subsystems is a function of the application that the fuel cell system serves.

Care must be exercised in shutting down and starting up a fuel cell stack for such purposes of preventing thermal combustion (due to potential hydrogen and oxygen mixing); preventing damage to the membranes of the fuel cell stack; and preventing corrosion/oxidation of components, such as preventing the corrosion of the cathode electrode.

### SUMMARY

In an embodiment of the invention, a technique includes shutting down operation of a fuel cell stack that includes an anode chamber and a cathode chamber. The shutting down includes storing fuel in the anode and cathode chambers of the fuel cell stack.

In a second embodiment of the invention, a fuel cell system includes a fuel cell stack and a control subsystem. The fuel cell stack includes an anode chamber and a cathode chamber. The control subsystem, in response to a transition of the fuel cell stack from a shut down state to an operational state, causes fuel that is stored in the cathode chamber to be transferred to the anode chamber.

In a third embodiment of the invention a fuel cell system includes a fuel cell stack and a control subsystem. The fuel cell stack includes an anode chamber and a cathode chamber. The control subsystem, in response to a transition of the fuel cell stack from a shutdown state to an operational state, causes fuel that is stored in the cathode chamber to be purged from the cathode chamber by a reactant air flow.

Advantages and other features of the invention will become apparent from the following drawing, description and claims.

### BRIEF DESCRIPTION OF THE DRAWING

FIGS. 1, 4, 7, 9, 13 and 15 are flow diagrams depicting techniques to shut down a fuel cell stack according to embodiments of the invention.

FIGS. 2, 5 and 14 are flow diagrams depicting techniques to start up a fuel cell stack according to embodiments of the invention.

FIGS. 3, 6, 8, 11 and 12 are schematic diagrams of fuel cell systems according to embodiments of the invention.

FIG. 10 is a flow diagram depicting a technique to maintain fuel in an anode chamber of a fuel cell stack when the stack is shut down according to an embodiment of the invention.

### DETAILED DESCRIPTION

When in its normal state of operation, a fuel cell stack generates electrical power due to electrochemical reactions (see Equations 1 and 2 above) that occur inside the stack. The electrochemical reactions are fed by fuel (hydrogen, for example) and oxidant (oxygen, for example) that are communicated to an anode chamber and a cathode chamber, respectively, of the fuel cell stack. The “anode chamber” refers to the region of the fuel cell stack, which communicates fuel, such as the anode flow plate channels and the fuel plenum; and the “cathode chamber” refers to the region of the fuel cell stack, which communicates oxidant to the stack, such as the cathode flow plate channels and the oxidant plenum.

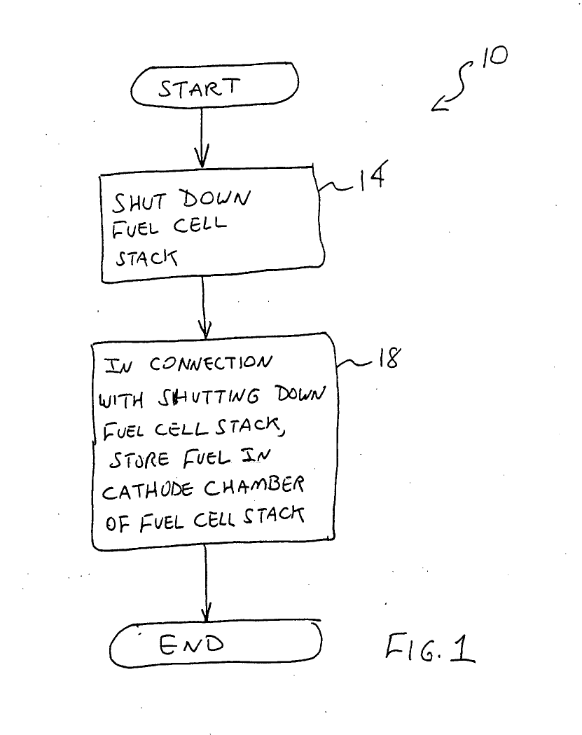

Referring to FIG. 1, in general, a technique 10 may be used for purposes of shutting down a fuel cell stack to place the stack in a shut down state, a state in which electrochemical reactions inside the stack are halted. The fuel cell stack remains in the shut down state until the stack “starts up,” or transitions back into its normal state of operation. Pursuant to the technique 10, the fuel cell stack is shut down (as depicted in block 14); and in connection with the shutting down of the fuel cell stack, fuel is stored in the cathode chamber of the fuel cell stack, as depicted in block 18. As further described below, as a result of the technique 10, the fuel cell stack stores fuel in both its anode and cathode chambers when shut down.

The advantages of storing fuel in the stack's anode and cathode chambers when the stack is shut down may include one or more of the following. No flammable hydrogen venting is conducted for purposes of shutting down the stack. The electrodes of the fuel cell stack are protected from corrosion/oxidation. No stored inert purge gas is required during startup, normal operation, stopping and/or storage. Fuel cell membranes are preserved. Thermal combustion inside the fuel cell stack is prevented. Other and/or different advantages may be possible in the numerous possible embodiments of the invention.

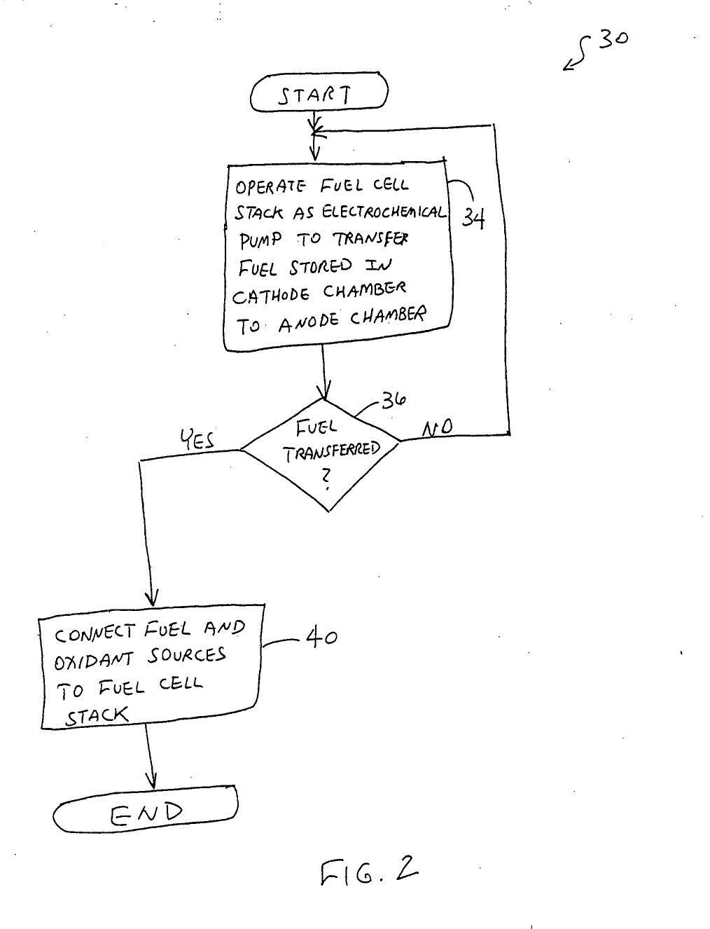

Additionally, by storing fuel in the anode and cathode chambers of the fuel cell stack, an ample supply of fuel is present at the startup of the fuel cell stack to accelerate the transition of the stack from its shut down state into its normal state of operation. Referring to FIG. 2, more specifically, a technique 30 to start up the fuel cell stack (that is shut down in accordance with the technique 10) includes operating (block 34) at least part of the fuel cell stack as an electrochemical pump to transfer fuel that is stored in the cathode chamber to the anode chamber. After the fuel has been transferred (see diamond 36), the fuel and oxidant sources are connected (block 40) to the fuel cell stack to resume normal operation of the stack. It is noted that pursuant to the technique 30, either a sufficient time may be allowed for the transfer of fuel from the cathode chamber, or the transfer may be monitored (as indicated by diamond 36) for purposes of determining when the fuel transfer is complete.

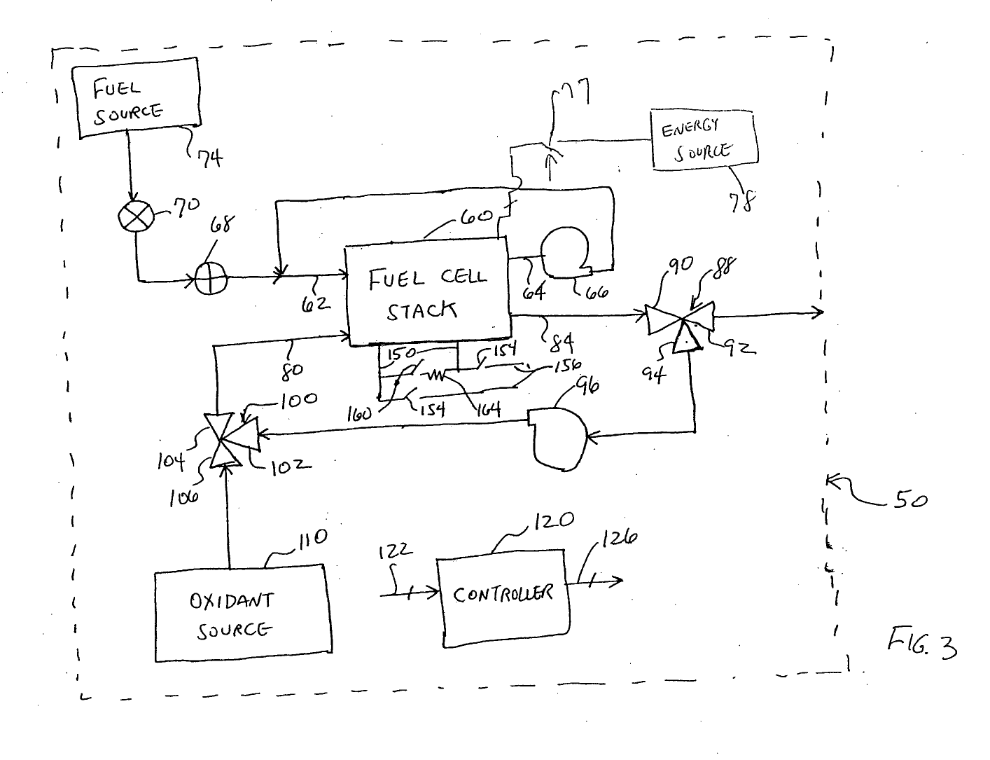

To further illustrate the above-described shut-down 10 and start-up 30 techniques, FIG. 3 illustrates an exemplary fuel cell system 50, in accordance with some embodiments of the invention. The fuel cell system 50 includes a fuel cell stack 60 that may, during its normal operation, provide electrical power to a load (a commercial or residential load, for example) and/or produce heat for a certain application (such as an application that involves heating a hot water tank, for example). During its normal state of operation, the fuel cell stack 60 provides a DC stack voltage across terminals 156, and the fuel cell system 50 may include a power conditioning system (not shown) for purposes of transforming the DC stack voltage into an AC voltage for a load of the fuel cell system 50.

As depicted in FIG. 3, the fuel cell stack 60 is “dead-headed,” which means that the anode exhaust (appearing at an anode exhaust outlet 64) of the fuel cell stack 60 is not communicated to a flare or oxidizer; but rather, the anode exhaust is circulated back to an anode inlet 62 of the fuel cell stack 60. The circulation is conducted so that the anode inert gas content is in equilibrium with the cathode. This circulation is in recognition that, during normal operation of the fuel cell stack 60, excess fuel (hydrogen, for example) is provided to the stack 60 so that not all of the fuel is consumed by the electrochemical reactions inside the stack 60. Thus, the remaining, or residual, fuel is circulated back to the anode chamber of the fuel cell stack 60 to generally improve the efficiency of the fuel cell system 50.

For purposes of establishing the fuel circulation, the fuel cell system 50 may include a circulation blower 66 that is coupled between the anode exhaust outlet 64 and the anode inlet 62 of the fuel cell stack 60. A fuel source 74 (a hydrogen storage tank as an example) provides an incoming fuel-containing flow (called a “fuel flow” herein) to the fuel cell stack 60, and the control of the fuel from the fuel source 74 is by demand via a pressure regulator 68. As depicted in FIG. 3, a shutoff valve 70 is coupled between the pressure regulator 68 and the fuel source 74, in some embodiments of the invention for purposes of controlling when the fuel source 74 is connected to the fuel cell stack 60 during the start up and shut down of the stack 60, as further described below.

The fuel cell stack 60 includes an oxidant inlet 80 that receives an oxidant-containing flow (called an “oxidant flow” herein), which may be air, in some embodiments of the invention. The incoming oxidant flow is routed through the cathode chamber of the fuel cell stack 60 and exits an oxidant outlet 84 of the stack 60. An oxidant source 110 (an air blower, for example) provides the incoming oxidant flow to the oxidant inlet 80. During operation of the fuel cell stack 60 in its normal state, the oxidant flow from the oxidant source 110 passes through a three-way valve 100 (which has two inlets and one outlet) to the oxidant inlet 80. More particularly, the oxidant flow from the oxidant source 110 passes through an inlet 106 of the valve 100 and is directed to an outlet 104 of the valve 100, which is connected to the oxidant inlet 80 of the fuel cell stack 60.

Another inlet 102 of the valve 100, when open, or enabled, establishes a circulation flow through the cathode chamber of the fuel cell stack 60. During operation of the fuel cell stack 60 in its normal state, however, the inlet 102 is closed so that exhaust oxidant is not circulated back to the oxidant inlet 80. However, as further described below, for purposes of shutting down and starting up the fuel cell stack 60, the oxidant circulation path is selectively opened and closed.

As depicted in FIG. 3, the oxidant circulation path also includes another three-way valve 88 (having one inlet and two outlets) and a circulation blower 96 (an air blower, for example). An outlet 94 of the valve 88 is connected to an inlet of the blower 96; and an outlet of the blower 96 is connected to the inlet 102 of the valve 100. An inlet 90 of the valve 88 is connected to the oxidant outlet 84; and another outlet 92 of the valve 88 is connected to an oxidant outlet for the fuel cell system 50. Therefore, due to the above-described arrangement, when the oxidant circulation path is enabled, the oxidant exhaust from the fuel cell stack 60 is routed to the inlet of the blower 96; and the outlet of the blower 96 is routed to the oxidant inlet 80. As further described below, when the oxidant circulation is enabled, the oxidant source 110 is shut off (by the valve 100) from the oxidant inlet 80; and all of the oxidant exhaust flow from the oxidant outlet 84 is routed back through the oxidant circulation path to the oxidant inlet 80.

Among the other features of the fuel cell system 50, in accordance with some embodiments of the invention, the fuel cell system 50 includes a controller 120 that is coupled to electrical communication lines 122 for purposes of receiving various sensor inputs, control signals, communication data, etc. from the other components of the fuel cell system 50. In this regard, via the communication lines 122, the controller 120 may be signaled when to start up or shut down the fuel cell stack 60; the controller 120 may monitor various flows and gas compositions of the fuel cell system 50; the controller 120 may measure cell voltages of the fuel cell stack 60; the controller 120 may determine ambient and operating temperatures of the system 50, etc.

The controller 120 generates output signals on electrical communication lines 126 for purposes of controlling various components of the fuel cell system 50. In this regard, the electrical communication lines 126 may be used, for example, for purposes of controlling valves (such as the valves 70, 88 and 100, for example), blowers, reformers, switches, etc. of the fuel cell system 50. Additionally, as shown in FIG. 3, the fuel cell system 50 may include switches 154 that are closed for purposes of coupling the fuel cell stack 60 to the terminals 156 (and load) and are opened for purposes of disconnecting the fuel cell stack 60 from the load. Furthermore, the fuel cell system 50 may include at least one switch 160 for purposes of connecting the fuel cell stack 60 to a small resistive load 164 (i.e., a relatively large resistor, as compared to the load that is connected to the stack 60 during normal operation) in connection with shutting down or starting up of the fuel cell stack, and in connection with maintaining the fuel cell stack 60 in its shut down state, as further described below.

The controller 120, along with other controlled components, such as the valves 70, 88 and 100, various gas composition sensors, temperature sensors, blower motors, etc., form a control subsystem for the fuel cell system 50, which among its other functions, controls operation of the fuel cell system 50 for purposes of implementing the shut down and start up techniques that are disclosed herein.

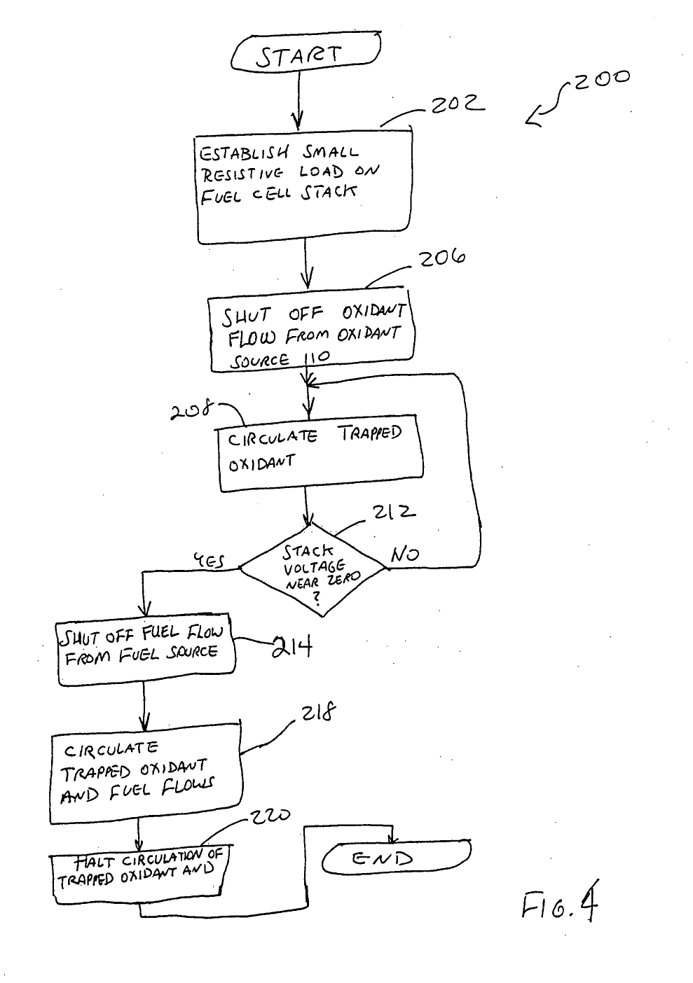

Referring to FIG. 4 in conjunction with FIG. 3, in accordance with some embodiments of the invention, a technique 200 may be used for purposes of shutting down the fuel cell stack 60, i.e., transitioning the fuel cell stack 60 from its normal state of operation to its shut down state. Pursuant to the technique 200, a small resistive load is established on the fuel cell stack 60, in accordance with block 202. Thus, the controller 120 (FIG. 3) may close the switch 160 (FIG. 3) and open the switches 154 (FIG. 3) for purposes of establishing a small resistive load on the stack 60. Next, pursuant to the technique 200, the oxidant flow is shut off from the oxidant source 110, pursuant to block 206. In this regard, the controller 120 may control the valve 100 so that the flow from the oxidant source 110 is shut off. Additionally, the controller 120 controls the valve 100 to establish flow from the oxidant circulation path to the oxidant inlet 80 in order that trapped oxidant is circulated through the cathode chamber of the fuel cell stack 60, pursuant to block 208.

During the circulation of the trapped oxidant, one or more parameters of the fuel cell system 50 may be monitored for purposes of determining when the oxidant has been substantially consumed by the electrochemical reactions inside the fuel cell stack 60. In this regard, in accordance with some embodiments of the invention, the controller 120 monitors the stack voltage to determine (diamond 212) when the stack voltage is near zero. As long as the stack voltage remains substantially above zero (more than 20 percent of the normal operating stack voltage, for example), the trapped oxidant continues to be circulated through the fuel cell stack 60 pursuant to block 208. When the stack voltage reaches approximately zero volts, the controller 120 closes the valve 70 to shut off (block 214) the fuel flow from the fuel source 74.

Subsequently, pursuant to the technique 200, the trapped oxidant and fuel chamber streams are circulated through the cathode and anode chambers, respectively, of the fuel cell stack 60. The circulation continues for a sufficient time (several seconds), for example); and circulation of the trapped oxidant and fuel flows is then halted, pursuant to block 220. At this point, virtually no oxidant remains in the fuel cell system 50 downstream of the oxidant source 110. Both the anode and cathode chambers at this point have a mixture of fuel (hydrogen, for example) and nitrogen. At first, the pressures may have an imbalance, but the imbalance is minimized with time, as normal gas diffusion tends to equalize the pressures. After establishment of this state of equilibrium, the fuel cell stack 60 is in the shut down state, a state in which fuel is stored in both the anode and cathode chambers.

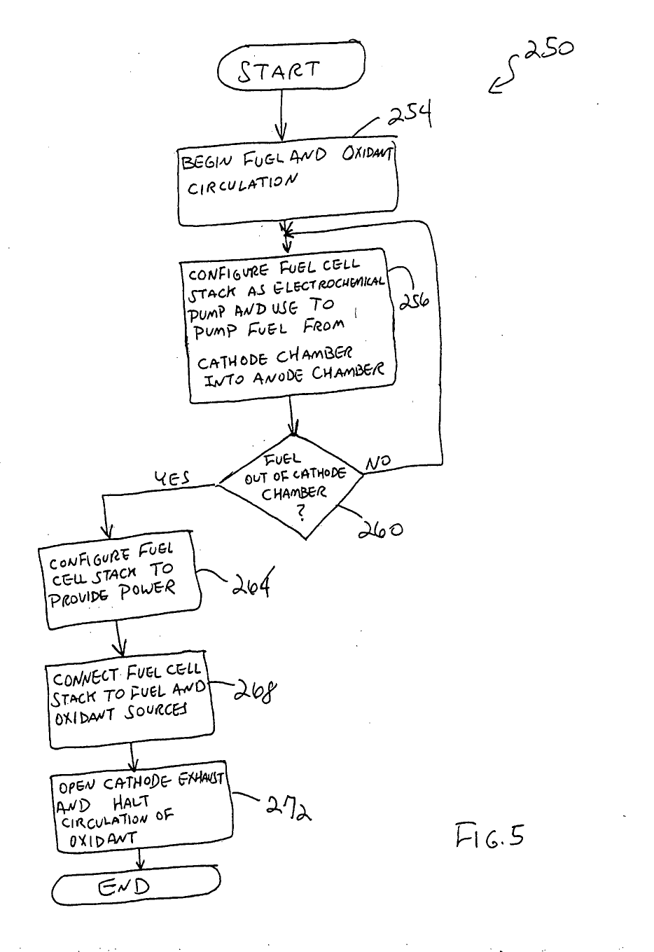

A technique 250 that is depicted in FIG. 5 may be used for purposes of starting up the fuel cell system 50, i.e., transitioning the fuel cell stack 60 from its shut down state to its normal state of operation. The start up may begin in response to a startup signal. The fuel source 74 and the oxidant source 110 remain disconnected from the fuel cell stack 60 pursuant to the disconnection of the fuel 74 and oxidant 110 sources during the shutting down of the fuel cell system 50. Referring to FIG. 5, pursuant to the technique 250, the valves 100 and 88 are configured and the blowers 66 and 96 are operated to begin circulating the trapped fuel and oxidant chamber streams, pursuant to block 254. While the trapped oxidant and fuel chamber streams are circulated, the controller 120 configures at least part of the fuel cell stack 60 as an electrochemical pump so that the fuel is pumped from the cathode chamber of the fuel cell stack 60 into the anode chamber. In this regard, the labeling “anode” and “cathode” refer to the labeling used in connection with the normal operation of the fuel cell stack.

In the pumping mode, the normal fuel cell cathode becomes the pump anode. To configure the fuel cell stack 60 as an electrochemical pump, the controller 120 may connect (via a switch 77) an energy source 781 (a battery, for example) to the fuel cell stack 60 to cause the migration of hydrogen ions to transfer fuel from the cathode to the anode chambers. The energy source 78 may be charged with power from the fuel cell stack 60 during its normal mode of operation, in some embodiments of the invention.

In accordance with some embodiments of the invention, the controller 120 waits for a sufficient time (a few seconds, for example) to occur for the fuel to be pumped from the cathode to the anode chambers of the fuel cell stack 60. In other embodiments of the invention, the controller 120 may monitor (via a sensor) the fuel content (hydrogen content, for example) in the cathode circulation path (for example) for purposes of determining when the pumping is complete. In response to a determination (diamond 260) that the fuel has been substantially removed from the cathode chamber, the controller 120 configures (block 264) the fuel cell stack 60 to provide power. In this regard, the controller 120 may open the switch 77 to disconnect the energy source 78 from the fuel cell stack 60. Next, pursuant to the technique 250, the controller 120 operates the valves 70 and 100 to connect the fuel cell stack 60 to the fuel 74 and oxidant 110 sources; and the controller 120 configures the valves 88 and 100 to open the cathode exhaust and halt circulation of the oxidant, pursuant to block 272. The controller 120 then closes the switches 154 and opens the switch 160.

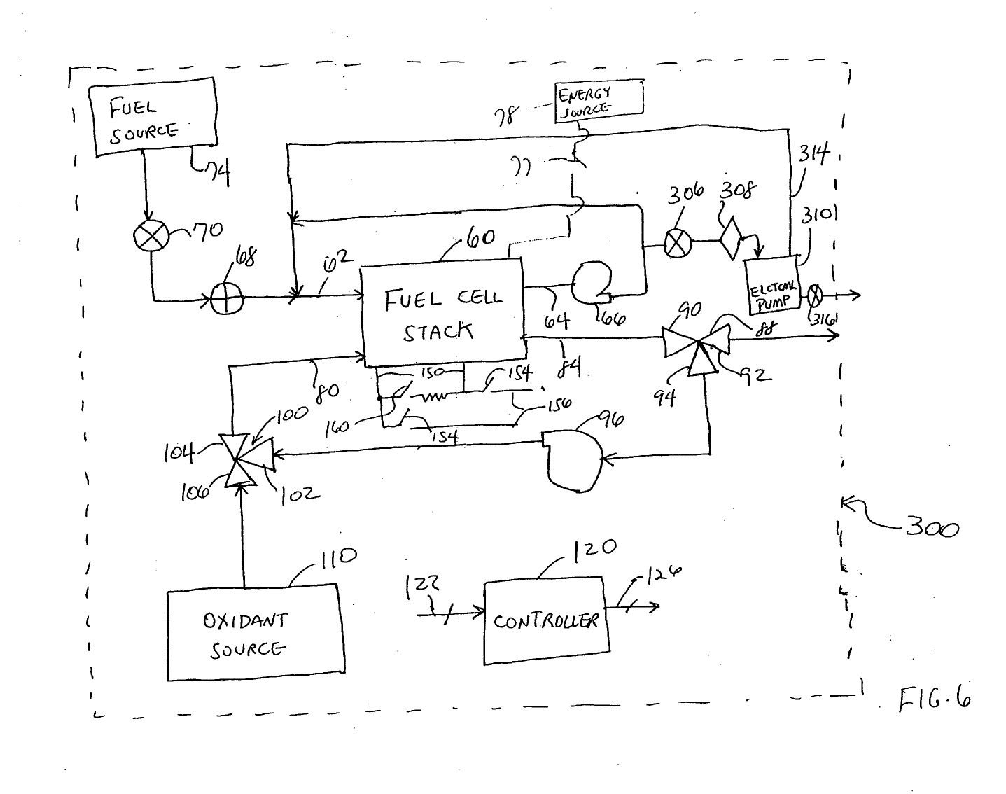

Referring to FIG. 6, in accordance with other embodiments of the invention, the above-described shut down and start up techniques may, in general, be used with another fuel cell system, such as a fuel cell system 300. The fuel cell system 300 has a similar design to the fuel cell system 50, with like reference numerals being used to designate similar components. Unlike the fuel cell system 50, however, the fuel cell system 300 includes a bleed path from the fuel circulation path. In this regard, as depicted in FIG. 6, unlike the fuel cell system 50, the fuel cell system 300 includes a bleed path that is connected to the fuel circulation path at the outlet of the blower 66. This bleed path includes a valve 306 that has its inlet connected to the outlet of the blower 66, and an outlet of the valve 306 is connected to the inlet of a pressure drop orifice 308. The outlet of the orifice 308 is connected to the inlet of an electrochemical pump 310 (a fuel cell stack that receives a pumping current, for example).

In accordance with some embodiments of the invention, the electrochemical pump 310 purifies the stream received through the bleed path for purposes of producing a significantly pure hydrogen stream that is provided at an outlet 314 of the pump 310. The outlet 314, in turn, is connected to the anode inlet 62 of the fuel cell stack 60. Thus, effectively two fuel circulation paths are established in the fuel cell system 300: a first circulation path which circulates the anode exhaust back to the anode inlet 62; and a second bleed circulation path that circulates a purified fuel flow back to the anode inlet 62. Nitrogen may be discharged to the ambient (through a valve 316) from the pump stack anode with trace quantities of hydrogen gas.

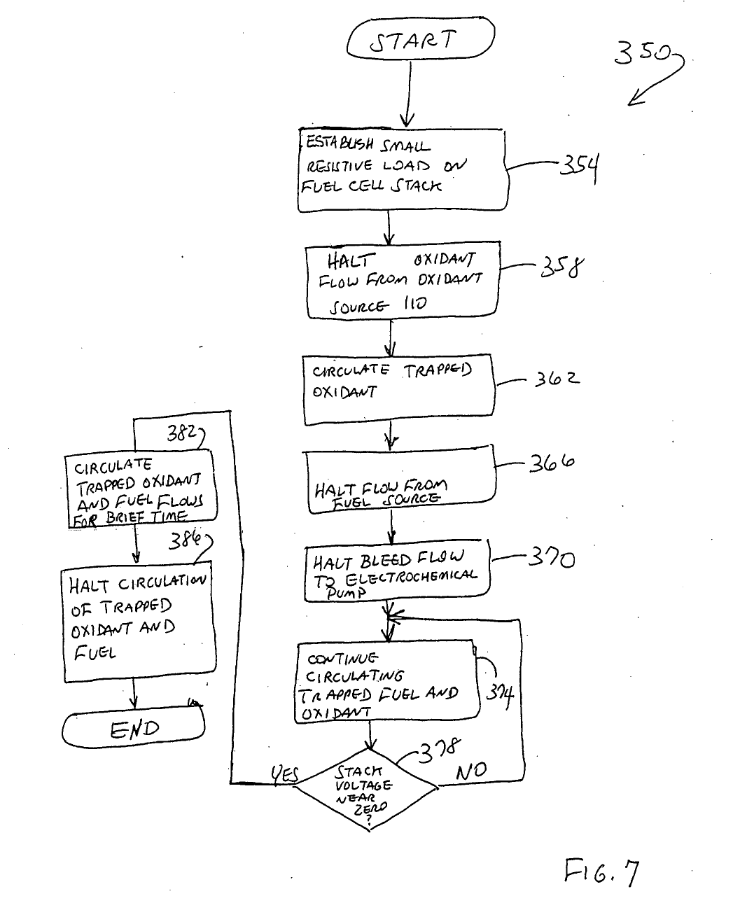

The fuel cell system 300 provides a significantly larger reserve of fuel in the anode chamber than the supply of oxidant in the cathode chamber. Due to this larger reserve of fuel, the flow from the fuel source 74 may be shut off sooner during the shut down of the fuel cell stack 60. More particularly, referring to FIG. 7 in conjunction with FIG. 6, in accordance with some embodiments of the invention, a technique 350 may be used to shut down the fuel cell stack 60 of the fuel cell system 300. Pursuant to the technique 350, a small resistive load is established on the fuel cell stack 60, as depicted in block 354. The oxidant flow from the oxidant source 110 is halted (block 358) and the oxidant circulation path is enabled to circulate the trapped oxidant, as depicted in block 362.

Next, pursuant to the technique 350, the fuel from the fuel source 74 is halted (block 366) and the bleed flow from the electrochemical pump 310 is also halted, pursuant to block 370. The circulation of the trapped fuel and oxidant continues (block 374) until a determination (diamond 378) is made that the stack voltage is near zero.

After the stack voltage has dropped to near zero, indicating substantial consumption of the remaining oxidant, the trapped oxidant and fuel flow streams are circulated for a brief time, pursuant to block 382, to permit the fuel to diffuse into the cathode chamber so that the fuel partial pressure in the anode and cathode chambers are nearly the same. Next, the circulation of trapped oxidant and fuel streams is halted, pursuant to block 386.

The fuel cell system 300 may be started up similar to the technique 250 that is depicted in FIG. 5. Because the fuel cell system 300 has a relatively larger fuel reserve than the fuel cell system 50, more time may be needed to transfer fuel to the anode chamber from the cathode chamber during start up.

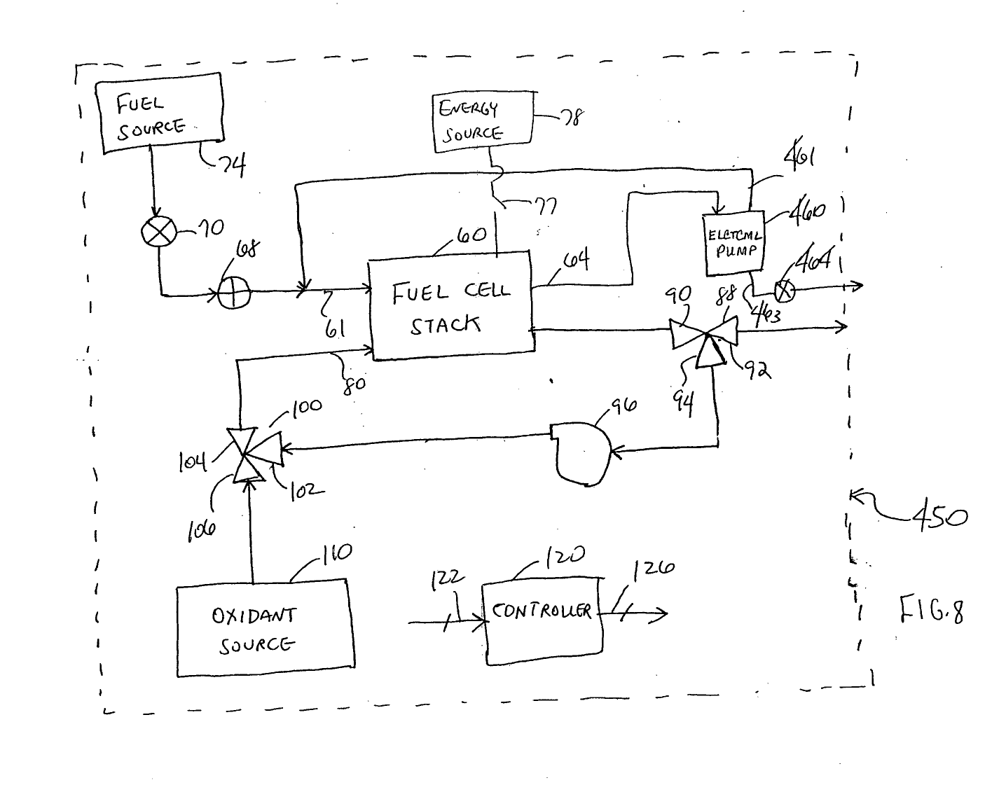

Referring to FIG. 8, in other embodiments of the invention, a fuel cell system 450 may be used in place of the fuel cell system 50 or 300. The fuel cell system 450 has a similar design to the fuel cell system 50 (see FIG. 3), with similar reference numerals being used to depict similar components. However, unlike the fuel cell system 50, the fuel cell system 450 has a fuel circulation path, which is established solely by an electrochemical pump 460. In some embodiments of the invention, the rate at which the electrochemical pump 460 pumps fuel is as much as approximately 50% of the fuel cell consumption rate. Thus, the electrochemical pump 460 replaces the blower 66 (see FIG. 3 for example) of the system 50, 300. The nitrogen in the anode stack outlet of the electrochemical pump 460 may be discharged to ambient via a valve 464 with trace quantifies of the fuel.

The anode exhaust outlet 64 of the fuel cell stack 60 is connected to an inlet of the electrochemical pump 460. The electrochemical pump 460 produces a substantially pure fuel flow at its outlet 461, which, in turn, is connected to the anode inlet 61 of the fuel cell stack 60. As also shown in FIG. 8, an effluent outlet 463 of the electrochemical pump 460 may be coupled to a valve 464 that controls communication between the outlet 463 and a fuel exhaust outlet of the fuel cell system 450.

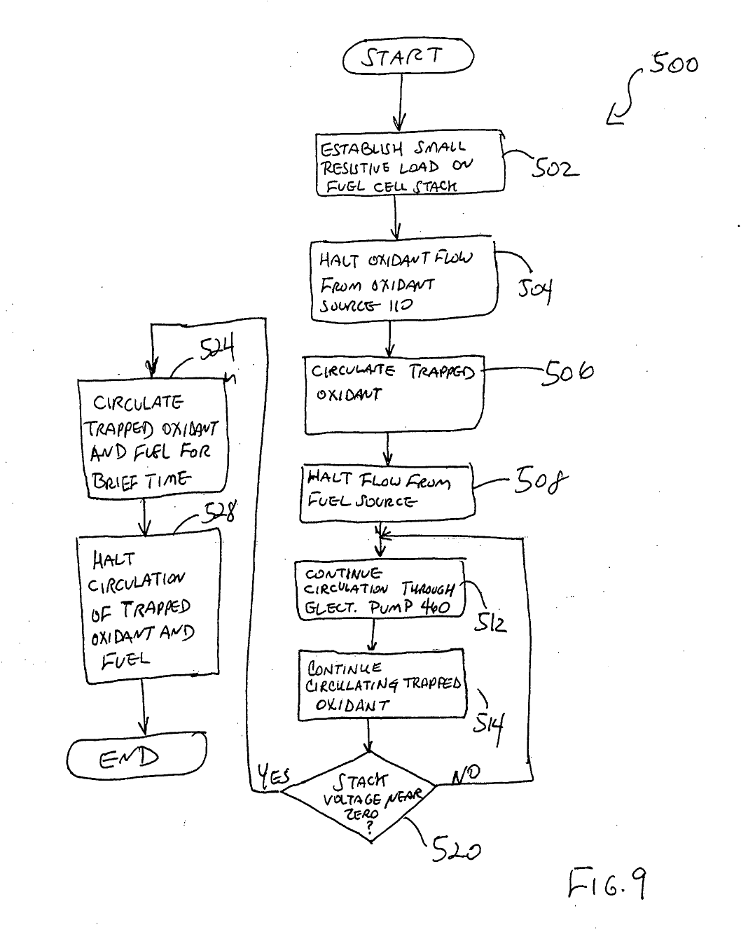

The fuel cell system 450 may be shut down pursuant to a technique 500 that is depicted in FIG. 9. Referring to FIG. 9 in conjunction with FIG. 8, in accordance with some embodiments of the invention, the technique 500 includes establishing (block 502) a small resistive load on the fuel cell stack 60. Next, the oxidant flow from the oxidant source 110 is halted (block 504) and then trapped oxidant is circulated (block 506). The flow from the fuel source 74 is then halted, pursuant to block 504. Subsequently, circulation continues through the electrochemical pump 460, as depicted in block 512, and circulation of the trapped oxidant continues, pursuant to block 514. The continuation of the circulation through the pump 460 and the circulation of the trapped oxidant continues until a determination (diamond 520) is made that the stack voltage is near zero.

After the stack voltage has reached approximately zero, the trapped oxidant and fuel streams are circulated for a brief time (pursuant to block 524), and then circulation of the trapped oxidant and fuel streams is halted, pursuant to block 528.

The fuel cell system 450 may be started up similar to the technique 250 that is depicted in FIG. 5. Because the fuel cell system 300 has a relatively larger fuel reserve than the fuel cell system 50, more time may be needed to transfer fuel to the anode chamber during start up.

As described above, fuel is stored in both the anode and cathode chambers during the shut down state of the fuel cell stack 60. However, in accordance with other embodiments of the invention, fuel may be stored in the anode chamber and not in the cathode chamber of the fuel cell stack when the stack is shut down. In this technique, measures are undertaken to ensure that no, or at least no significant, accumulation of fuel occurs in the cathode chamber when the fuel cell stack is in its shut down state.

The advantages of this technique may include one or more of the following. Keeping fuel in the anode chamber permits rapid startup of the fuel cell stack. By maintaining fuel in the anode chamber, a combustible mixture is prevented from forming within the fuel cell stack. Other and/or different advantages are possible in the many possible embodiments of the invention.

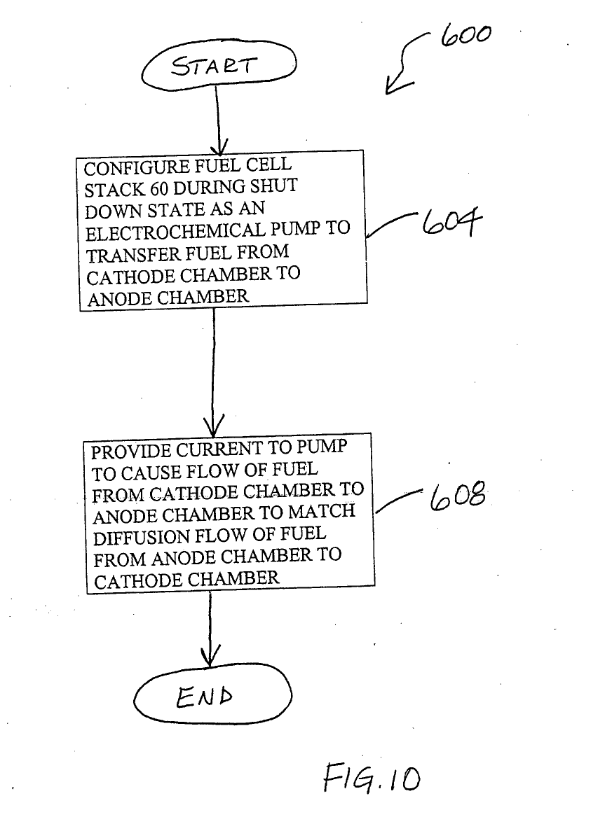

As a more specific example, referring to FIG. 10, in accordance with some embodiments of the invention, a technique 600 includes configuring (block 604) at least part of the fuel cell stack 60 as an electrochemical pump during the stack's shut down state to transfer fuel from the cathode chamber to the anode chamber. This transfer, in turn, counters the diffusion of fuel from the anode chamber to the cathode chamber. Therefore, because the fuel cell stack 60 is operated as an electrochemical stack during the fuel cell stack's shut down state, any fuel that diffuses from the anode chamber to the cathode chamber is pumped back into the cathode chamber. A current is provided (block 608) to the fuel cell stack to cause a rate at which fuel flows from the cathode chamber to the anode chamber (due to the pumping) to substantially match a rate at which fuel flows from the anode chamber to the cathode chamber (due to diffusion).

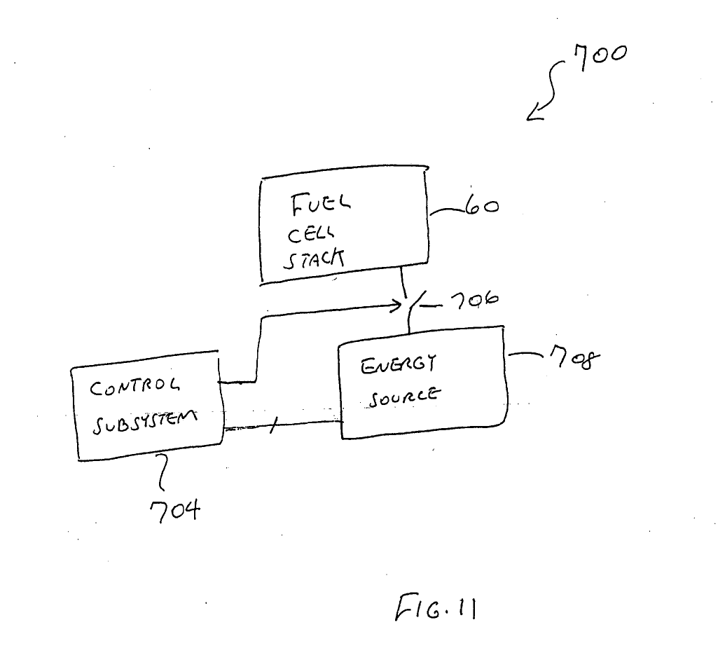

Therefore, referring to FIG. 11, in accordance with some embodiments of the invention, a fuel cell system 700 includes a control subsystem 704 that controls (via a switch 706) when an energy source 708 (a battery, for example) is connected to the stack 60. Therefore, during the shut down of the fuel cell stack 60, the control subsystem 704 may close the switch 706 and regulate the current that flows from the energy source 708 to the stack 60 for purposes of controlling the pumping of fuel from the cathode chamber to the anode chamber. In some embodiments of the invention, the energy source 708 may be charged via power from the fuel cell stack 60 during the stack's normal mode of operation.

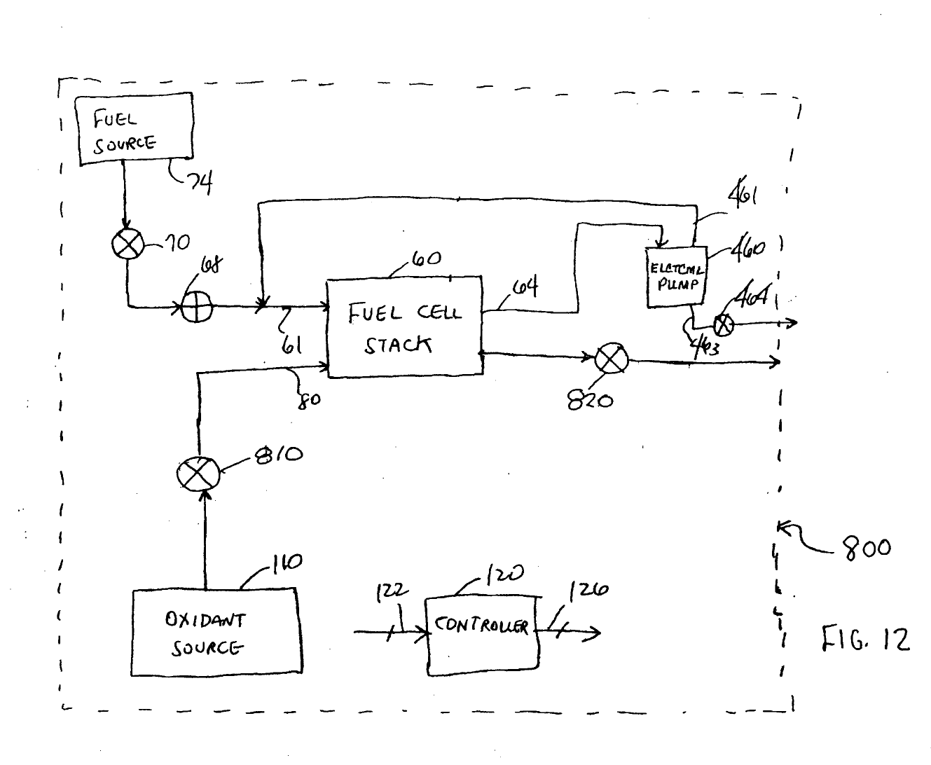

Referring to FIG. 12, in another more specific example of an embodiment of the invention, a fuel cell system 800 may be used in place of the fuel cell system 50, 300, or 450. The fuel cell system 800 has a similar design to the fuel cell system 450 (see FIG. 8), with similar reference numerals being used to depict similar components. However, unlike the fuel cell system 450, the fuel cell system 800 has no cathode circulation path. Valves 810 and 820 replace three-way valves 100 and 88 respectively.

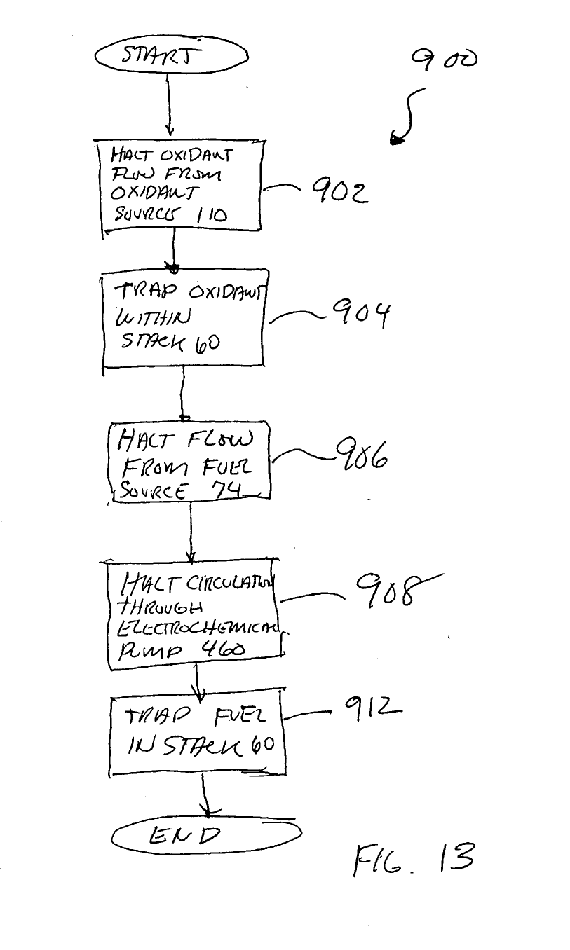

The fuel cell system 800 may be shut down pursuant to a technique 900 that is depicted in FIG. 13. Referring to FIG. 13 in conjunction with FIG. 12, in accordance with some embodiments of the invention, the technique 900 includes halting (block 902) the oxidant flow from the oxidant source 110 by closing the valve 810. Next, the technique 800 includes trapping the oxidant between the valves 810 and 820 within the stack, as depicted in block 904, by also closing the valve 820. The flow from the fuel source 74 is then halted, pursuant to block 906, by closing the valve 70. Subsequently, circulation through the electrochemical pump 460 is halted as depicted in block 908, to trap fuel within the stack anode, pursuant to block 912.

The fuel cell system 800 may be started up by establishing fuel flow and circulation followed by establishing oxidant flow.

As an example of yet another embodiment of the invention, in connection with transitioning the fuel cell stack from a shutdown state to an operational state, the control subsystem may use a reactant air flow to purge fuel that is stored in the cathode chamber from the cathode chamber. Thus, for example, referring to FIG. 12, the controller 120 may open the cathode path valves 810 and 820 during the startup of the fuel cell system 800 for purposes of purging the cathode chamber of the fuel cell stack 60 with an oxidant flow. Therefore, in accordance with some embodiments of the invention, an electrochemical pump may not be used to transfer stored fuel from the cathode to the anode chambers upon start up of the fuel cell system.

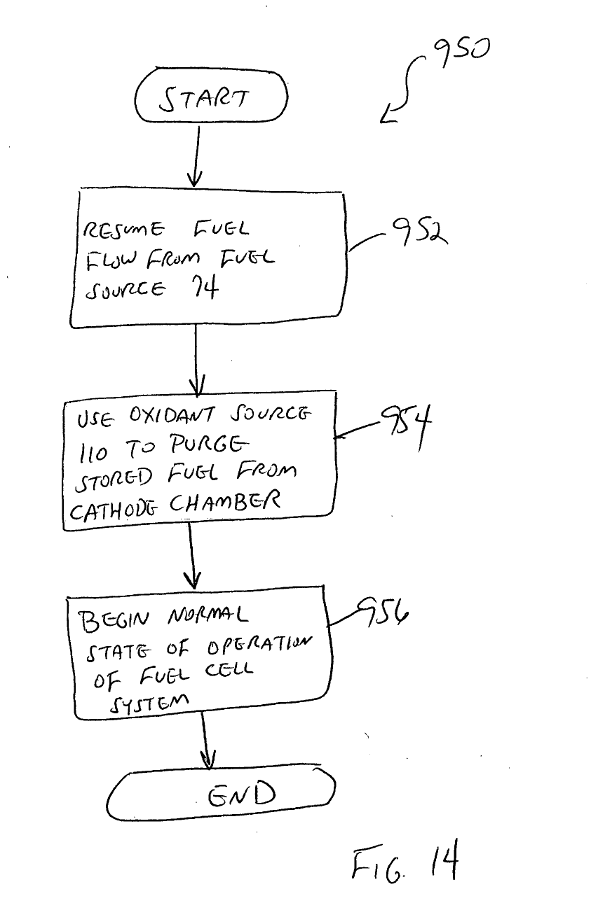

As a more specific example, FIG. 14 depicts a start up technique 950 that uses a reactant air flow to purge stored fuel from the cathode chamber according to some embodiments of the invention. It is assumed that fuel is stored in both the anode and cathode chambers of the fuel cell stack pursuant to one of shutdown techniques that are described herein. Pursuant to the technique 950, at the beginning of the start up, the fuel flow from the fuel source 74 is resumed (block 952). The oxidant source 110 is then used (block 954) to purge stored fuel from the cathode chamber of the fuel cell stack. As an example, an air blower may be connected (via the opening of a valve) to the fuel cell stack and operated at an increased air output flow for purposes of purging stored fuel from the cathode chamber using the reactant air flow. Subsequently, the normal state of operation of the fuel cell system may begin, as depicted in block 956.

The fuel cell systems 50, 300, 450 and 800 that are described above may be used with a pure hydrogen source, in accordance with some embodiments of the invention. Therefore, in accordance with some embodiments of the invention, the fuel source 74 may be a hydrogen tank or another source of substantially pure hydrogen. Thus, the “fuel flow” to the fuel cell stack 60 as well as any “fuel” that is stored in the stack 60 during shutdown may be substantially pure hydrogen. However, in the context of this application, the terms “fuel flow” and “fuel” are not to be limited to substantially pure hydrogen. For example, in other embodiments of the invention the “fuel flow” to the fuel cell stack 60 may be from a source other than a source of substantially pure hydrogen; and the fuel that is stored in the cathode chamber may not be substantially pure hydrogen.

More specifically, in accordance with some embodiments of the invention, propane, methane or some other hydrogen-containing feed stock may be run through a chemical reactor (i.e., a reformer) to create reformate, which may form the fuel flow to the fuel cell stack. The reformate may, for example, contain about fifty percent hydrogen, with the balance being inert gases, such as nitrogen and carbon dioxide, in some embodiments of the invention.

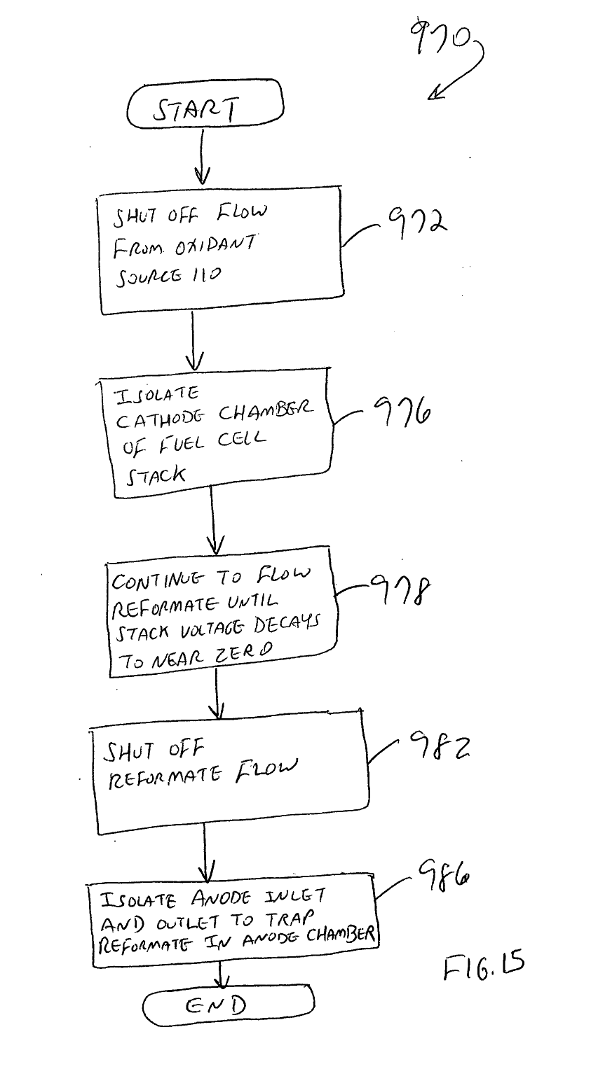

As a more specific example, a system that uses reformate may use the reformate to effect a cathode hydrogen takeover during shut down, in accordance with some embodiments of the invention. More particularly, referring to FIG. 15, in accordance with some embodiments of the invention, a technique 970 to shut down a fuel system that uses reformate includes shutting off flow from the oxidant source 110, as depicted in block 972. Next, the cathode chamber of the fuel cell stack is isolated (block 976). For example, the valves on both the inlet and outlet of the cathode chamber may be closed. Next, pursuant to the technique 970, the flow of reformate to the fuel cell stack continues until the stack voltage decays to near zero, as depicted in block 978. The reformate flow is then shut off, as depicted in block 982. Subsequently, the anode inlet and outlet are isolated to trap reformate in the anode chamber, as depicted in block 986.

For embodiments of the invention that use reformate, exhaust gas from the outlet of the anode chamber of the fuel cell stack may or may not be circulated back to the anode inlet of the fuel cell stack. Thus, no blower-induced anode recirculation path may exist from the anode exhaust to the anode inlet. It may be more challenging to run such a reformate system in a deadheaded mode, since with a dilute anode stream the build up of the inert gas is much faster. Therefore, in accordance with some embodiments of the invention, fuel cell systems that use a reformate flow do not have anode exhaust recirculation. It is noted that some amount of wasted fuel may be desirable (such as for purposes of creating steam in the reformer, for example).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
shutting down operation of a fuel cell stack comprising an anode chamber and a cathode chamber, the shutting down comprising storing fuel in the anode and cathode chambers of the fuel cell stack.

2. The method of claim 1, wherein the fuel comprises one of substantially pure hydrogen furnished by a hydrogen source and reformate furnished by a reformer.

3. The method of claim 1, wherein the act of storing fuel comprises:
storing fuel in the anode and cathode chambers until the fuel cell stack resumes operation.

4. The method of claim 1, wherein the act of shutting down comprises removing substantially all of an oxidant from the cathode chamber.

5. The method of claim 1, wherein the act of shutting down comprises:
halting an oxidant flow to the cathode chamber from an oxidant source; and
providing a fuel flow to the anode chamber until trapped oxidant is substantially removed from the cathode chamber.

6. The method of claim 1, wherein the act of shutting down comprises:
halting an oxidant flow to the cathode chamber from an oxidant source;
halting a fuel flow to the anode chamber from a fuel source; and
halting circulation of a fuel circulation flow through an electrochemical pump subsequent to the halting of the oxidant and fuel flows.

7. The method of claim 5, further comprising:
trapping oxidant within the fuel cell stack after the halting of the oxidant flow from the oxidant source.

8. The method of claim 5, further comprising:
trapping fuel in the fuel cell stack after circulation through the electrochemical pump is halted.

9. The method of claim 1, wherein the act of shutting down comprises:
halting an oxidant flow from an oxidant source to the cathode chamber creating trapped oxidant in the cathode chamber;
providing a fuel flow from a fuel source to the anode chamber; and
halting the fuel flow in response to a voltage of the fuel cell stack indicating the trapped oxidant is substantially removed from the cathode chamber.

10. The method of claim 8, further comprising:
circulating the trapped oxidant after the oxidant flow is halted.

11. The method of claim 8, wherein the halting of the fuel flow creates trapped fuel in the anode chamber, the method further comprising:
circulating the trapped fuel after the fuel flow is halted.

12. A method comprising:
transitioning a fuel cell stack from a shut down state to a state in which the fuel cell stack produces electrical power, the fuel cell stack comprising an anode chamber and a cathode chamber and the transitioning comprising transferring fuel stored in the cathode chamber to the anode chamber.

13. The method of claim 12, wherein transferring comprises:
pumping the fuel stored in the cathode chamber to the anode chamber.

14. The method of claim 12, wherein fuel is stored in the anode chamber of the fuel cell stack during the shut down state.

15. The method of claim 12, wherein the transferring comprises:
operating at least part of the fuel cell stack as an electrochemical pump to transfer the fuel stored in the cathode chamber to the anode chamber.

16. A fuel cell system comprising:
a fuel cell stack comprising an anode chamber and a cathode chamber; and
a control subsystem adapted to cause fuel to be stored in the anode and cathode chambers of the fuel cell stack during a shut down state of the fuel cell stack.

17. The fuel cell system of claim 16, further comprising:
a circulation path to route an effluent flow from an outlet of the anode chamber to an inlet of the anode chamber.

18. The fuel cell system of claim 17, wherein circulation path comprises a blower.

19. The fuel cell system of claim 17, wherein circulation path comprises an electrochemical pump.

20. The fuel cell system of claim 19, wherein the control subsystem is adapted to halt oxidant flow to the cathode chamber from an oxidant source, halt flow from a fuel source to the anode chamber and halt flow through the electrochemical pump in connection with shutting down the fuel cell stack.

21. The fuel cell system of claim 19, wherein the control subsystem is further adapted to trap oxidant within the fuel cell stack in connection with shutting down the stack.

22. The fuel cell system of claim 19, wherein the control subsystem is further adapted to trap fuel in the fuel cell stack in connection with shutting down the fuel cell stack.

23. The fuel cell system of claim 19, wherein the pump receives a bleed flow from another circulation path that routes an effluent flow from the outlet of the anode chamber to the inlet of the anode chamber.

24. The fuel cell system of claim 16, wherein the anode chamber stores fuel during the shut down state.

25. The fuel cell system of claim 16, wherein the control subsystem, in response to the fuel cell stack transitioning from an operational state to the shut down state, is adapted to substantially remove oxidant from the cathode chamber of the fuel cell stack.

26. The fuel cell system of claim 16, wherein the control subsystem, in response to the fuel cell stack transitioning from an operational state to the shut down state, is adapted to halt oxidant flow from an oxidant source to the cathode chamber to create trapped oxidant and flows fuel to the anode chamber until the trapped oxidant is substantially removed.

27. The fuel cell system of claim 12, wherein the fuel comprises one of substantially pure hydrogen furnished by a hydrogen source and reformate furnished by a reformer.

28. A fuel cell system comprising:
a fuel cell stack comprising an anode chamber and a cathode chamber; and
a control subsystem to, in response to a transition of the fuel cell stack from a shut down state to an operational state, transfer fuel stored in the cathode chamber to the anode chamber.

29. The fuel cell system of claim 28, wherein the control subsystem causes the cathode chamber stored fuel to be pumped from the cathode chamber to the anode chamber in response to the transition.

30. The fuel cell system of claim 28, wherein the control subsystem is adapted to configure at least part of the fuel cell stack as an electrochemical pump to transfer the fuel.

31. A method comprising:
placing a fuel cell stack in a shut down state, the fuel cell stack comprising an anode chamber and a cathode chamber; and
during the shut down state, storing fuel in the anode chamber and operating at least part of the fuel cell stack as an electrochemical pump to counter a diffusion of the fuel from the anode chamber to the cathode chamber.

32. The method of claim 31, wherein the act of operating comprises causing fuel to be pumped from the cathode chamber to the anode chamber at approximately the same rate as the diffusion of the fuel from the anode chamber to the cathode chamber.

33. The method of claim 31, further comprising:
operating the fuel cell stack to produce power for a load in response to the fuel cell stack transitioning from the shut down state into an operational state.

34. The method of claim 31, wherein the operating comprises:
applying a current to the fuel cell stack.

35. A fuel cell system comprising:
a fuel cell stack comprising an anode chamber and a cathode chamber; and
a control subsystem adapted to:
place the fuel cell stack in a shut down state, and
during the shut down state, store fuel in the anode chamber and operate at least part of the fuel cell stack as an electrochemical pump to counter a diffusion of the fuel from the anode chamber to the cathode chamber.

36. The fuel cell system of claim 35, wherein the control subsystem is further adapted to cause fuel to be pumped from the cathode chamber to the anode chamber at approximately the same rate as the diffusion of the fuel from the anode chamber to the cathode chamber.

37. The fuel cell system of claim 35, wherein the control subsystem is further adapted to operate the fuel cell stack to produce power for a load in response to the fuel cell stack transitioning from the shut down state into an operational state.

38. The fuel cell system of claim 35, wherein the control subsystem is adapted to apply a current to the fuel cell stack to operate said at least part of the fuel cell stack as the electrochemical pump.

39. A fuel cell system comprising:
a fuel cell stack, the fuel cell stack including an anode chamber and a cathode chamber; and
a control subsystem adapted to in response to a transition of the fuel cell stack from a shutdown state to an operational state, cause fuel that is stored in the cathode chamber to be purged from the cathode chamber by a reactant air flow.

40. The fuel cell system of claim 39, wherein the control subsystem resumes fuel flow from a fuel source to the fuel cell stack before purging the cathode chamber.
